(19) United States
(12) Patent Application Publication
(10) Pub. No.: US 2026/0074255 A1
(43) Pub. Date: Mar. 12, 2026

(54) METHOD FOR MANUFACTURING MULTISCALE-STRUCTURED METAL SUPPORT FOR LOW-TEMPERATURE THIN-FILM SOLID OXIDE FUEL CELL, AND METAL SUPPORT MANUFACTURED THEREBY

(71) Applicant: SEOUL NATIONAL UNIVERSITY R&DB FOUNDATION, Seoul (KR)

(72) Inventors: Suk Won CHA, Seoul (KR); Won Yeop JEONG, Seoul (KR); In Won CHOI, Seoul (KR); Jae Won HWANG, Seoul (KR)

(73) Assignee: SEOUL NATIONAL UNIVERSITY R&DB FOUNDATION, Seoul (KR)

(21) Appl. No.: 19/392,899

(22) Filed: Nov. 18, 2025

Related U.S. Application Data
(63) Continuation of application No. PCT/KR2023/019113, filed on Nov. 24, 2023.

(30) Foreign Application Priority Data
May 24, 2023 (KR) 10-2023-0066838

(51) Int. Cl. H01M 8/1097; B22F 7/08

(52) U.S. Cl. CPC H01M 8/1097; B22F 7/08

(57) ABSTRACT

Provided is a method for manufacturing a multiscale structured metal support for low-temperature thin-film solid oxide fuel cells and to a metal support manufactured thereby. The method includes (a) filling the pores on the surface of a porous metal support with a first metal powder having a relatively large particle size; (b) filling the pores on the surface of the porous metal support with a second metal powder having a relatively small particle size and pressing the surface; (c) heat-treating the porous metal support, whose surface pores are filled with the first and second metal powders, in a reducing atmosphere; and (d) filling the pores on the surface of the heat-treated porous metal support with a ceramic powder and heat-treating the resulting support in a reducing atmosphere. Through these processes, a multiscale structured metal support suitable for application in low-temperature thin-film solid oxide fuel cells can be fabricated.

### CROSS-REFERENCE TO RELATED APPLICATIONS

This application is a continuation of International Application No. PCT/KR2023/019113 filed on Nov. 24, 2023, which claims priority to Korean Patent Application No. 10-2023-0066838 filed on May 24, 2023, the entire contents of which are herein incorporated by reference.

### TECHNICAL FIELD

The present invention relates to a method for manufacturing a metal support constituting a solid oxide fuel cell and to a metal support manufactured by the same method.

### BACKGROUND ART

Despite decades of global efforts to prevent global warming, the average temperature of the Earth continues to rise. In order to limit the continuously increasing carbon dioxide emissions, it is essential to develop alternative clean energy sources, and interest in fuel cells as an alternative energy system is steadily increasing. Among various types of fuel cells, solid oxide fuel cells (SOFCs) have been attracting attention as the most promising candidates to replace fossil fuels because of their high efficiency.

SOFCs, which operate at high temperatures of 800-1000° C., not only exhibit high efficiency but also allow the use of various kinds of fuels and do not require noble-metal catalysts. However, the high operating temperature leads to rapid degradation of the system and limits the selection of applicable materials. Due to these issues, commercialization of SOFCs has faced significant challenges.

Therefore, to improve the technological level of SOFCs, it is necessary to develop cells that exhibit superior electrochemical performance even in low-temperature regions. Under low-temperature operating conditions, both ohmic loss and polarization resistance increase compared with those at high temperatures, and minimizing such losses is the only way to achieve the desired performance.

One approach to reducing ohmic loss is to employ a thin-film electrolyte. Unlike conventional high-temperature sintering processes, which produce electrolytes with thicknesses on the order of tens of micrometers, thin-film electrodes and electrolytes can be fabricated by physical vapor deposition (PVD) and chemical vapor deposition (CVD) methods, thereby significantly reducing ohmic resistance.

However, in order to apply thin-film processes, the pores of the support must be smaller than several micrometers, and the surface must be uniform. Because of these limitations, thin-film processes have not been applicable to metal supports that are advantageous for commercialization.

### DISCLOSURE OF INVENTION

### Technical Problem

The technical problem to be solved by the present invention is to provide a method for manufacturing a metal support applicable to a thin-film process by controlling the surface of the metal support through an easy and simple procedure, as well as to provide a metal support manufactured by the same method.

### Technical Solution

In order to achieve the above-described technical problem, the present invention proposes a method for manufacturing a multiscale structured metal support having a surface functional layer with nanoscale pores and roughness by controlling the surface of a metal support with microscale pores and roughness, the method comprising the steps of: (a) filling the pores on the surface of a porous metal support with a first metal powder having a relatively large particle size; (b) filling the pores on the surface of the porous metal support with a second metal powder having a relatively small particle size and pressing the surface; (c) heat-treating the porous metal support, whose surface pores are filled with the first and second metal powders, in a reducing atmosphere; and (d) filling the pores on the surface of the heat-treated porous metal support with a ceramic powder and heat-treating the resulting support in a reducing atmosphere. Through the above steps, the surface of the metal support having microscale pores and roughness is controlled to form a multiscale structure having a surface functional layer characterized by nanoscale pores and surface roughness, thereby providing a method for manufacturing a multiscale structured metal support suitable for thin-film applications.

In step (a), the pores present on one surface of the porous metal support are filled with a first metal powder having a relatively larger particle size compared to that of the second metal powder, thereby primarily reducing the pore size and surface roughness of the metal support surface.

Although the method for filling the surface pores of the metal support with the first metal powder is not particularly limited, it is preferable to use a vacuum filtration process to fill the pores with the first metal powder.

The term “vacuum filtration process” used herein refers to a method in which one side of the metal support is depressurized using equipment such as a vacuum pump to generate a pressure difference between one side and the opposite side of the metal support, thereby allowing the metal or ceramic powder located near the surface of the opposite side to be drawn into and filled within the pores present on the surface of the opposite side of the metal support.

Next, in step (b), the pores on the surface of the porous metal support are filled with a second metal powder having a relatively smaller particle size than that of the first metal powder, thereby further reducing the pore size and surface roughness of the metal support surface. Subsequently, the surface of the metal support is pressed using a pressing device or the like, thereby planarizing the surface and further decreasing its surface roughness.

As in step (a), it is also preferable in this step to use a vacuum filtration process to fill the pores in the surface region of the metal support that remain unfilled during step (a) with the second metal powder.

The first and second metal powders may each be composed of the same pure metal or alloy, or they may be composed of different pure metals or alloys.

For example, the first and second metal powders may be made of one metal or alloy selected from the group consisting of Ni, Zr, Ce, Ti, Mg, Al, Si, Mn, Fe, Co, Cu, Zn, Mo, Y, Nb, Sn, La, Ta, V, and Nd, and preferably, the powders are made of nickel (Ni).

Nickel possesses high electronic conductivity and exhibits excellent catalytic activity for hydrogen and hydrocarbon fuel adsorption, while also having the advantage of being much less expensive than noble metals such as platinum (Pt).

In step (c), the porous metal support, whose surface pores have been filled with the first and second metal powders, is heat-treated in a reducing atmosphere to agglomerate the particles of the first and second metal powders, thereby imparting mechanical rigidity to the metal support.

For example, when the surface pores of the metal support are filled with first and second metal powders composed of nickel (Ni), the support may be sintered at 700° C., which is higher than the target operating temperature of the solid oxide fuel cell (≤500° C.) but lower than the melting point of Ni. During this sintering process, the Ni powder particles are intentionally agglomerated and interconnected, thereby securing mechanical rigidity of the metal support while simultaneously forming electrical connections between the Ni particles and the metal support.

Finally, in step (d), the pores and/or defects that appear on the surface of the metal support due to particle agglomeration and interconnection during the heat treatment of step (c) are filled with a ceramic powder and heat-treated again in a reducing atmosphere. Through this process, the surface state of the metal support is more precisely controlled, and the pore size and surface roughness are further reduced.

As in step (a), it is also preferable in this step to use a vacuum filtration process to fill the pores and/or defects generated during the heat treatment of step (c) with the ceramic powder.

The ceramic powder is preferably composed of an inorganic oxide having oxygen-ion conductivity.

For example, the ceramic powder may be made of one selected from gadolinium-doped ceria (GDC), gadolinium-doped zirconia (GDZ), samarium-doped ceria (SDC), samarium-doped zirconia (SDZ), yttrium-doped ceria (YDC), yttrium-doped zirconia (YDZ), yttria-stabilized zirconia (YSZ), and scandia-stabilized zirconia (ScSZ), and is more preferably composed of gadolinium-doped ceria (GDC).

In another aspect, the present invention provides a multiscale structured metal support manufactured according to the above-described method.

Furthermore, in still another aspect, the present invention provides a solid oxide fuel cell (SOFC) including the multiscale structured metal support according to the invention, the SOFC comprising: the multiscale structured metal support; a fuel electrode (anode) formed on the metal support; an electrolyte layer formed on the fuel electrode; and an air electrode (cathode) formed on the electrolyte layer.

### Advantageous Effects

According to the present invention, by controlling the surface of a support having microscale pores and surface roughness using metal powders and ceramic powders of different particle sizes, a multiscale structured porous metal support can be fabricated that possesses machinability and stacking suitability. The multiscale structured porous metal support thus produced satisfies the requirements necessary for thin-film processes and can therefore be effectively utilized in the fabrication of high-performance low-temperature thin-film solid oxide fuel cells (SOFCs).

### DESCRIPTION OF DRAWINGS

FIG. 1 is a schematic diagram sequentially illustrating the process of manufacturing a multiscale structured metal support according to an embodiment of the present invention.

FIG. 2 shows FE-SEM images of the surface microstructure of the metal support obtained at each step in the process of manufacturing the multiscale structured metal support according to an embodiment of the present invention.

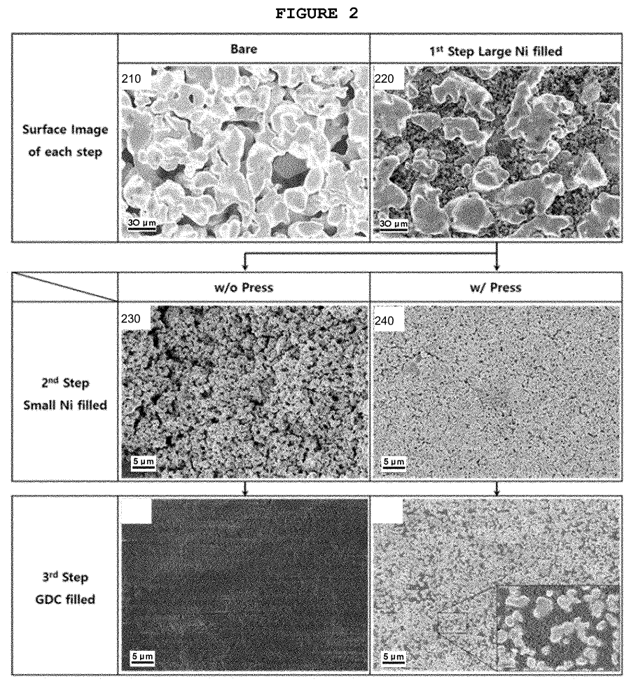

FIG. 3 shows FE-SEM cross-sectional images comparing a bare porous stainless-steel metal support (Bare SS) before pore filling with nickel powder and a surface-modified stainless-steel support (Surface Modified SS) whose pores have been filled with two types of nickel powders having different particle sizes.

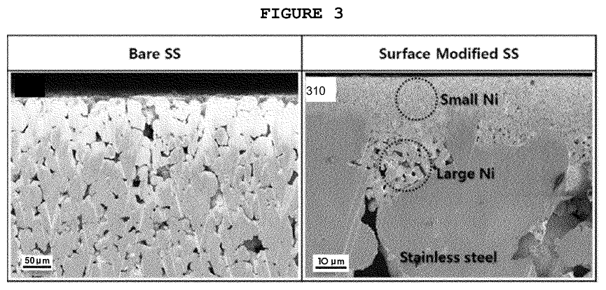

FIG. 4 shows FE-SEM images comparing the surface morphologies of the NiO/GDC fuel electrode and the YSZ electrolyte layer deposited on the multiscale structured metal support depending on whether the compression (pressing) process was performed, according to an embodiment of the present invention.

FIG. 5 shows the measurement results of the electrochemical performance (I-V-P curves) of the thin-film solid oxide fuel cell fabricated using the multiscale structured metal support according to an embodiment of the present invention, depending on the electrode composition ratio (NiO:GDC).

FIG. 6 shows the results of the thermal cycling test of the thin-film solid oxide fuel cell fabricated using the multiscale structured metal support according to an embodiment of the present invention.

### MODE FOR INVENTION

In describing the present invention, detailed descriptions of well-known functions or configurations will be omitted when it is determined that such descriptions could unnecessarily obscure the gist of the invention.

Embodiments according to the concept of the present invention can be variously modified and implemented in multiple forms. Accordingly, specific embodiments are illustrated in the drawings and will be described in detail in the specification and application. However, this is not intended to limit the embodiments of the present invention to the particular forms disclosed herein, and it should be understood that all modifications, equivalents, and alternatives falling within the spirit and scope of the present invention are included.

The terminology used in this specification is intended merely to describe particular embodiments and is not intended to limit the invention. Singular expressions include plural forms unless the context clearly dictates otherwise. In this specification, the terms “include” and “have,” and any variations thereof, are intended to specify the presence of stated features, integers, steps, operations, elements, or components, or combinations thereof, but do not preclude the possibility of the presence or addition of one or more other features, integers, steps, operations, elements, or components, or combinations thereof.

Hereinafter, the present invention will be described in more detail with reference to exemplary embodiments.

The embodiments described in this specification may be modified in various other forms, and the scope of the present specification should not be construed as being limited to the embodiments described below. The embodiments are provided merely to enable those skilled in the art to understand the invention more fully.

### EXAMPLE

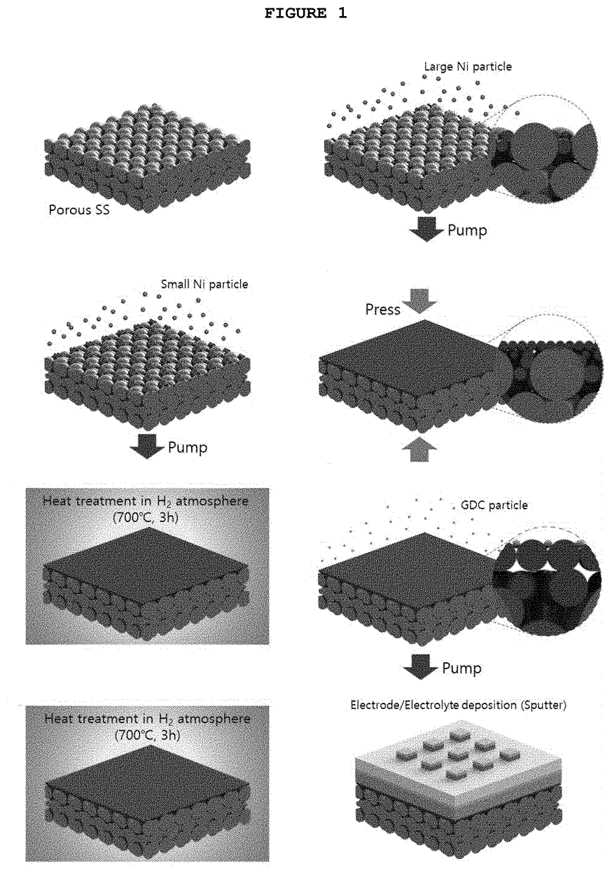

In this embodiment, as illustrated in FIG. 1, a vacuum filtration process was employed to sequentially fill nickel particles of two different sizes (large Ni particles and small Ni particles) into the pores of a porous stainless-steel (SS) metal support, and finally, ceramic particles (GDC particles) were used to further reduce the surface pore size and roughness. After each vacuum filtration step using the nickel and GDC particles, the substrate was sintered at 700° C. in a hydrogen environment, thereby forming a rigid nickel network without degradation of the metal support. Through this process, a metal support having a surface composed of pores on the order of several tens of nanometers was fabricated, and it was verified that the surface was suitable for the application of thin-film deposition processes.

First, a porous stainless-steel (SS) 316L sheet was laser-cut into 1×1 cm² pieces, and the metal support was cleaned sequentially in acetone, ethanol, and deionized water for 10 minutes each in an ultrasonic bath.

As shown in an image 210, the bare porous stainless-steel metal support (Bare SS) before pore filling with nickel powder exhibited irregular pores of 20-30 μm in size. On such a substrate having large pores and a rough surface, thin-film deposition using physical vapor deposition (PVD) methods such as sputtering cannot be performed effectively.

Among the two nickel powders having different particle sizes (<50 μm and <1 μm), 200 mg of large Ni powder (<50 μm) was dispersed in ethanol and vacuum-filtered twice using a custom vacuum filtration device to fill the pores of the metal support, after which the excess powder remaining on the surface was carefully removed. To use only appropriately sized particles, the dispersion was allowed to settle for 3 minutes, and only the suspended fraction was used.

During the vacuum filtration process, very fine nickel particles pass through the metal support, while particles larger than the pore size remain on the surface; only particles of suitable size fill the gaps between the pores. As a result, as shown in an image 220, only particles of about 2-3 μm in size remained between the pores of the metal support. However, even after the first step of the surface modification process, the pore structure of the substrate surface did not change noticeably.

Next, 10 mg of small Ni powder (<1 μm) was dispersed in ethanol by ultrasonic treatment for 10 minutes, followed by vacuum filtration. Without removing the excess powder remaining on the surface, the metal support was pressed at 10 MPa using a polished pressing plate (2000 grit, R_{q}=127 nm) to compact the structure. The pressed metal support was then subjected to reduction heat treatment at 700° C. for 3 hours.

When comparing the microstructures of the metal supports after pore filling with small Ni powder through vacuum filtration, depending on whether the pressing process was performed, it was found that in the case without pressing, the pore size at the upper surface of the metal support was reduced from several tens of micrometers to several micrometers, as shown in an image 230, and the surface roughness also decreased to 1.45 μm. Furthermore, by performing additional vacuum filtration with GDC10 powder followed by reduction heat treatment, the pore size was reduced to the nanoscale, and the surface roughness was further decreased to below 1 μm.

In contrast, when the pressing process was applied, the surface roughness and pore size were significantly reduced compared with the case without pressing, as shown in an image 240. This effect occurs because, during the compression of the excess Ni powder layer, the surface morphology of the metal support is influenced by the surface texture of the pressing plate in contact with it. The surface morphology of the substrate is affected not only by the surface roughness of the pressing plate but also by the magnitude of the applied pressure.

When the pressing process is applied, the Ni particles are packed more densely, and a greater number of particles become interconnected, thereby enhancing structural stability and electronic conductivity after the subsequent reduction sintering process. As illustrated in an image 310, this results in the formation of a nanoporous Ni layer approximately 10 μm thick on the microporous metal support, demonstrating the formation of a mechanically robust and electrically conductive multiscale structure.

Subsequently, 5 mg of GDC10 powder (gadolinium-doped ceria containing 10 mol % Gd, particle size <500 nm) was dispersed and vacuum-filtered using the same method as for the small Ni powder. After vacuum filtration, the GDC10 powder was heat-treated under the same reduction conditions as the Ni powder sintering, and the excess powder on the surface was carefully removed to obtain the multiscale structured metal support.

On the multiscale structured metal support fabricated as described above, a NiO-GDC thin-film anode was deposited by sputtering using Ni and GDC20 targets, and a YSZ (yttria-stabilized zirconia) electrolyte layer was deposited on the anode by sputtering using a Y—Zr (16:84 at %) alloy target.

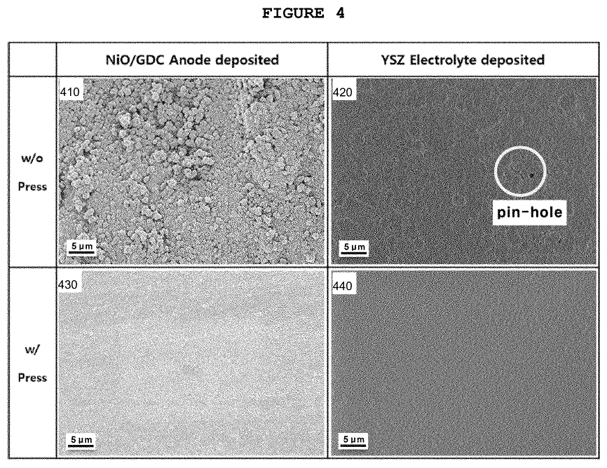

FIG. 4 presents scanning electron microscope (SEM) images showing the differences in the surface microstructures of the fuel electrode and the electrolyte layer depending on whether the pressing process was applied during fabrication of the multiscale structured metal support.

In the case without pressing, as shown in an image 410, the sputtered atoms grew irregularly due to the extremely rough and uneven surface morphology of the metal support. As a result, the deposited anode did not exhibit a uniform surface suitable for subsequent deposition of a dense electrolyte layer. As shown in an image 420, the surface of the electrolyte layer deposited on this rough anode showed reduced irregular particles due to the presence of the YSZ layer and a marked improvement in surface roughness. However, the electrolyte film exhibited insufficient density, with numerous pinholes observed on the surface.

In contrast, as shown in images 430 and 440, the pressed metal support exhibited highly uniform surfaces for both the sputtered electrode and the electrolyte layer. This improvement is attributed to the denser packing of excess Ni powder during the pressing step, which led to a controlled and uniform surface roughness. The surface morphology analysis confirmed that on the metal support prepared according to the present invention, a dense, pinhole-free electrolyte layer could be deposited to a thickness of approximately 1 μm by sputtering. This demonstrates that the metal support of the present invention is suitable for application in thin-film solid oxide fuel cells.

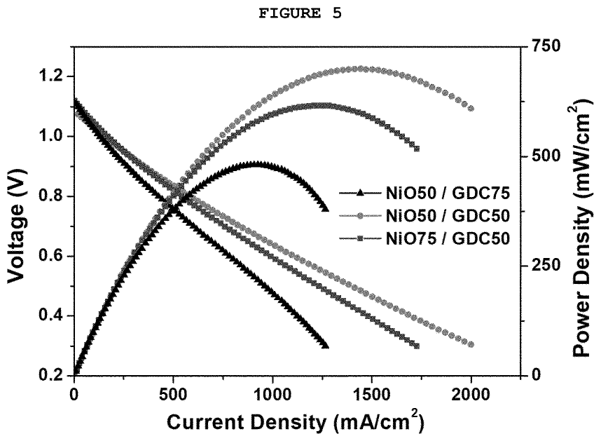

FIG. 5 illustrates the electrochemical performance (I-V-P curves) of the multiscale metal-supported thin-film solid oxide fuel cells (SOFCs) fabricated according to the present invention, depending on the electrode composition (NiO:GDC). The anode was a sputtered NiO-GDC composite, and the electrolyte was a sputtered YSZ (yttria-stabilized zirconia) layer. For each electrode—NiO50/GDC75, NiO50/GDC50, and NiO75/GDC50—the numerical values following NiO and GDC indicate the power (W) applied to each sputtering target. For instance, “NiO50/GDC50” denotes an electrode fabricated under sputtering conditions of 50 W for NiO and 50 W for GDC. As shown in FIG. 5, regardless of the electrode composition, all cells exhibited open-circuit voltages (OCVs) close to the theoretical value (˜1.10 V), indicating that the electrolyte layer was fabricated without pinholes. Moreover, when the optimized electrode (NiO50/GDC50) was used, the cell achieved a maximum power density of 699.83 mW/cm² at 500° C., which represents the highest performance ever reported among metal-supported solid oxide fuel cells to date.

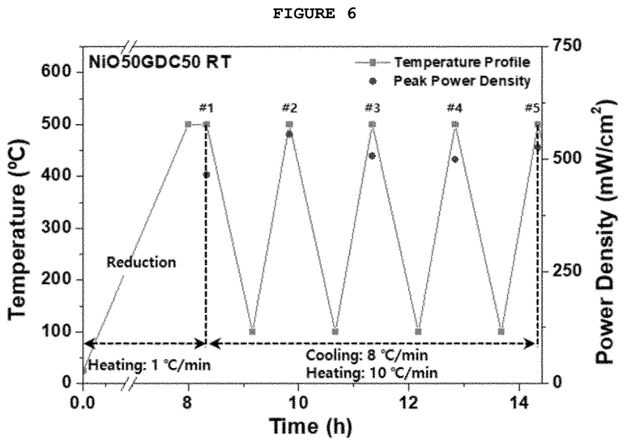

In actual SOFC operation, the internal cells are subjected to various operating conditions, such as thermal cycling. To evaluate the thermal durability of the multiscale metal support fabricated according to the present invention, a thermal cycling test was conducted on the thin-film SOFC incorporating this metal support. The results are presented in FIG. 6 and in the table below. As shown, no significant performance degradation was observed even after five thermal cycles, demonstrating that the metal support of the present invention possesses excellent thermal stability and durability.

| | Cycle 1 | Cycle 2 | Cycle 3 | Cycle 4 | Cycle 5 |
|---|---|---|---|---|---|
| Peak Power | 466.0 | 554.8 | 506.8 | 499.0 | 525.9 |
| Density (mW/cm²) | | | | | |

The present invention is not limited to the embodiments described above and may be manufactured in various alternative forms. It will be apparent to those skilled in the art that various modifications and equivalent embodiments can be made without departing from the spirit or essential characteristics of the invention. Therefore, the embodiments described herein are to be understood as illustrative and non-limiting in all respects.

### INDUSTRIAL APPLICABILITY

The multiscale structured porous metal support fabricated according to the present invention satisfies the requirements necessary for thin-film process application and can be effectively utilized in the manufacture of high-performance, low-temperature thin-film solid oxide fuel cells (SOFCs).

1. A method for manufacturing a multiscale structured metal support, comprising:
(a) filling pores on a surface of a porous metal support with a first metal powder having a relatively large particle size;
(b) filling the pores on the surface of the porous metal support with a second metal powder having a relatively small particle size and pressing the surface;
(c) heat-treating the porous metal support, whose surface pores are filled with the first and second metal powders, in a reducing atmosphere; and
(d) filling the pores on the surface of the heat-treated porous metal support with a ceramic powder and heat-treating the resulting support in a reducing atmosphere.

2. The method for manufacturing a multiscale structured metal support according to claim 1,
wherein, in steps (a), (b), and (d), the pores on the surface of the porous metal support are filled with the first metal powder, the second metal powder, and the ceramic powder, respectively, by using a vacuum filtration process.

3. The method for manufacturing a multiscale structured metal support according to claim 1,
wherein the first and second metal powders are each composed of one metal or an alloy selected from the group consisting of Ni, Zr, Ce, Ti, Mg, Al, Si, Mn, Fe, Co, Cu, Zn, Mo, Y, Nb, Sn, La, Ta, V, and Nd.

4. The method for manufacturing a multiscale structured metal support according to claim 1,
wherein the ceramic powder is composed of one or more ceramics selected from the group consisting of gadolinium-doped ceria (GDC), gadolinium-doped zirconia (GDZ), samarium-doped ceria (SDC), samarium-doped zirconia (SDZ), yttrium-doped ceria (YDC), yttrium-doped zirconia (YDZ), yttria-stabilized zirconia (YSZ), and scandia-stabilized zirconia (ScSZ).

5. The method for manufacturing a multiscale structured metal support according to claim 1, comprising:
(a) filling the pores on the surface of a porous stainless-steel metal support with a first nickel (Ni) powder having a relatively large particle size by using a vacuum filtration process;
(b) filling the pores on the surface of the porous metal support with a second nickel (Ni) powder having a relatively small particle size and pressing the surface by using a vacuum filtration process;
(c) heat-treating the porous metal support, whose surface pores are filled with the first and second nickel (Ni) powders, in a reducing atmosphere at a temperature of 700° C.; and
(d) filling the pores on the surface of the heat-treated porous metal support with a gadolinium-doped ceria (GDC) powder and heat-treating the resulting support in a reducing atmosphere at a temperature of 700° C.

6. A multiscale structured metal support manufactured according to claim 1.

7. A solid oxide fuel cell comprising:
a multiscale structured metal support according to claim 6;
a fuel electrode (anode) formed on the metal support;
an electrolyte layer formed on the fuel electrode; and
an air electrode (cathode) formed on the electrolyte layer.
